(19) United States
(12) Patent Application Publication
(10) Pub. No.: US 2016/0265742 A1
(43) Pub. Date: Sep. 15, 2016

(54) OPTICAL LENS AND LED LIGHT MODULE FOR BACKLIGHTING

(71) Applicant: GE LIGHTING SOLUTIONS, LLC, East Cleveland, OH (US)

(72) Inventors: Suping WANG, Shanghai (CN); Jeffrey Marc NALL, East Cleveland, OH (US); Brian Morgan SPAHNIE, East Cleveland, OH (US); Xiaojuan ZHANG, Shanghai (CN); Yan NI, Shanghai (CN); Shanshan XIE, Shanghai (CN)

(21) Appl. No.: 15/032,609

(22) PCT Filed: Oct. 31, 2013
(86) PCT No.: PCT/CN2013/086320

§ 371 Date: Apr. 27, 2016

(51) Int. Cl. F21V 5/08; F21V 5/00; G09F 13/04; F21V 5/04

(52) U.S. Cl. CPC F21V 5/08; F21V 5/04; F21V 5/007; G09F 13/04; F21Y 2101/02; G09F 2013/049

(57) ABSTRACT

An LED light module for illuminating a target plane is provided. The LED light module includes a first LED source, a second LED source disposed adjacent the first LED source, a first lens covering the first LED source, and a second lens covering the second LED source. The first lens is configured to direct first light beams emitted from the first light source to the target plane. The second lens is configured to direct second light beams emitted from the second light source to the target plane. At least one of the first and second lenses is shaped to have an asymmetrical profile. A backlighting system and a fixture incorporating the LED light module are also provided.

### BACKGROUND

Embodiments of the present disclosure relate generally to LED lighting, and more particularly to, backlighting LED systems for illuminating a target surface of a fixture such as a channel letter sign.

Channel letters are metal or plastic letters that are commonly used on the buildings of business and other organizations for exterior signage. At least some of the channel letters include a backlighting system which employs a plurality of light emitting diode (LED) devices for illuminating a front face of the channel letter, so that the channel letter is viewable in a dark environment. Traditionally, to reduce the amount of LED devices used in the channel letters at least for cost and energy saving reasons, multiple optical lenses are used to distribute the light beams emitted from the plurality of LED devices in a manner to allow the light beams to be uniformly distributed on the front face even though the LED devices may not be evenly spaced apart from each other behind the front face of the sign.

One exemplary design of the optical lens that has been proposed for use with the channel letter is described in US patent application publication US 2013/0042510 A1, entitled “LED Lighting Module for Backlighting,” by Nall et al. As described in this patent application, the lens has a rotated symmetrical profile or has a spherical outer surface which evenly distributes light beams emitted from the LED devices. One limitation in association with the use of the rotated symmetrical profile lens is that the LED light module constructed with the lens and the LEDs may not be able to be fit into a channel letter having a shallow depth and/or a narrow width. Another limitation in association with the use of the rotated symmetrical profile lens within a narrow channel letter is that the efficiency of the LED light module is low due to the amount of light that needs to reflect from the narrow side walls.

Therefore, it is desirable to provide an improved optical lens and an LED light module incorporating the improved lens to address at least one of the limitations of the prior lens design.

### BRIEF DESCRIPTION

In accordance with one aspect of the present disclosure, an LED light module for illuminating a target plane is provided. The LED light module includes a first LED source, a second LED source disposed adjacent the first LED source, a first lens covering the first LED source, and a second lens covering the second LED source. The first lens is configured to direct first light beams emitted from the first light source to the target plane. The second lens is configured to direct second light beams emitted from the second light source to the target plane. At least one of the first and second lenses is shaped to have an asymmetrical profile.

In accordance with another aspect of the present disclosure, a backlighting system is provided. The backlighting system includes a plurality of LED light modules electrically coupled with one another. One of the plurality of LED light modules includes a circuit board, a first LED source mounted on the circuit board, a second LED source mounted on the circuit board, and an optical element mounted on the circuit board and covering both the first LED source and the second LED source. The optical element is configured to distribute the light beams emitted from at least one of the first and second LED sources into asymmetrical light patterns.

In accordance with another aspect of the present disclosure, a fixture for presenting a visible sign to a viewer is provided. The fixture includes a target plane and a backlighting system for directing light beams to the target plane. The backlighting system includes a plurality of LED light modules electrically coupled with one another. One of the plurality of LED light modules includes a circuit board, a first LED source mounted on the circuit board, a second LED source mounted on the circuit board, and an optical element mounted on the circuit board and covering both the first LED source and the second LED source. The optical element is configured to distribute the light beams emitted from at least one of the first and second LED sources into a first light pattern and a second light pattern different than the first light pattern.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a backlighting system in accordance with an exemplary embodiment of the present disclosure;

FIG. 2 is a cross-sectional view of an LED light module of the backlighting system shown in FIG. 1 taken along line 1-1 in accordance with one exemplary embodiment of the present disclosure;

FIG. 3 is a perspective view of an optical element used in the LED light module shown in FIG. 2 in accordance with another exemplary embodiment of the present disclosure;

FIG. 4 is a cross-sectional view of the optical element shown in FIG. 3 taken along line 2-2 in accordance with an exemplary embodiment of the present disclosure;

FIG. 5 is a polar plot illustrating a light distribution pattern of light beams emitted from one LED light module in accordance with an exemplary embodiment of the present disclosure;

FIG. 6 is an illuminance distribution of light beams emitted from one LED light module in accordance with an exemplary embodiment of the present disclosure; and

FIG. 7 is an illuminance distribution of light beams provided from a plurality of LED light modules in accordance with an exemplary embodiment of the present disclosure.

### DETAILED DESCRIPTION

Embodiments of the present disclosure are directed to an improved optical element used in a backlighting system or an LED light module. More specifically, an optical element configured with an asymmetrical optical profile is proposed for distributing light pattern asymmetrically in a target plane. One technical benefit or advantage in association with the use of the asymmetrical optical element is that the LED light module constructed with the proposed optical element can be fit into a fixture such as a channel letter can with a shallow depth and/or a narrow width. Another technical benefit or advantage in association with the use of the asymmetrical optical element is that the overall efficiency is improved. Yet another technical advantage or benefit in association with the use of the asymmetrical optical element is the LED count for LEDs located between two parallel sidewalls in a display lighting device or an enclosure can be minimized. The sidewalls could be reflective, translucent, and/or transparent. For example, the LED light module could be used between two pieces of glass or plastic to create lighting effects within fixtures or displays by spreading light uniformly down the channel between the faces. Other technical advantages or benefits will become apparent to those skilled in the art by referring to the detailed descriptions and accompanying drawings provided below in accordance with one or more embodiments of the present disclosure.

In an effort to provide a concise description of these embodiments, not all features of an actual implementation are described in the one or more specific embodiments. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Unless defined otherwise, technical and scientific terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either any, several, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect.

As used in the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum. Some examples of LEDs include, but are not limited to, various types of infrared LEDs, ultraviolet LEDs, red LEDs, blue LEDs, green LEDs, yellow LEDs, amber LEDs, orange LEDs, and white LEDs. It also should be appreciated that LEDs may be configured to generate radiation having various bandwidths for a given spectrum (e.g., narrow bandwidth, broad bandwidth).

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

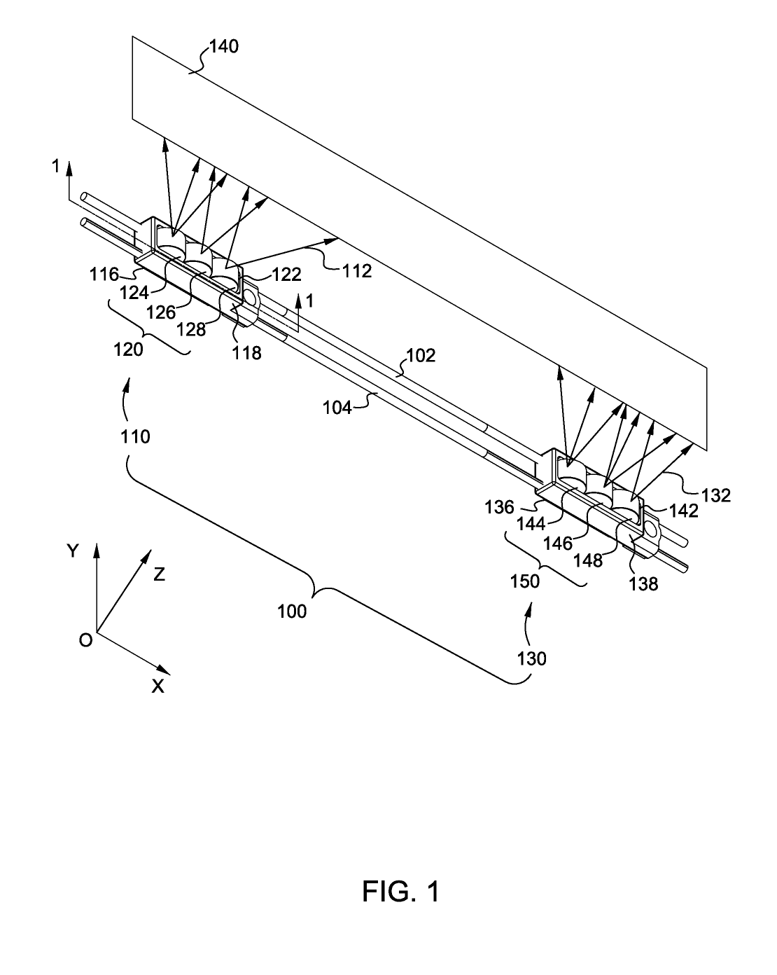

Referring to FIG. 1, a perspective view of a backlighting system 100 in accordance with an exemplary embodiment of the present disclosure is illustrated. The backlighting system 100 can be used in a fixture such as a channel letter or any other appropriate display lighting devices and enclosures. As shown in FIG. 1, the back lighting system 100 includes a first LED light module 110 and a second LED light module 130. The first LED light module 110 and the second LED light module 130 may be disposed at an inner space defined by the channel letter can. The first LED light module 110 and the second LED light module 130 are configured to illuminate at least one surface such as a top surface of the channel letter to present a visible sign to a viewer in a dark environment. In one embodiment, the first LED light module 110 and the second LED light module 130 are electrically connected with one another in a serial manner via two electrical conductors 102, 104, such as electrical wires. In some embodiments, the two electrical conductors 102, 104 may be arranged to be flexible or retractable, such that a distance between the first LED light module 110 and the second LED light module 130 can be adjusted according to practical requirements. Although two LED light modules are illustrated, in other embodiments, it is contemplated that fewer or more LED light modules may be used in the backlighting system 100 for a particular application. In some embodiments, additionally or alternatively, two or more LED light modules may be electrically connected in parallel manner.

In some embodiments, the first LED light module 110 and the second LED light module 130 may be mounted to a channel letter can in any appropriate means. For example, as shown in FIG. 1, a double-side tape 116 attached to the bottom surface of a housing 118 of the first LED light module 110 can be used to fix the first LED light module 110 to an inner surface (e.g., back surface or bottom surface) of a channel letter can (not shown). In other embodiments, the first LED light module 110 may be fixed to the inner surface of the channel letter can using screws or any other appropriate fasteners. In a similar manner, as shown in FIG. 1, another double-side tape 136 attached to the bottom surface of a housing 138 of the second LED light module 130 can be used to fix the second LED light module 130 to an inner surface (e.g., back surface or bottom surface) of the channel letter can. In other embodiments, the second LED light module 110 may be fixed to the inner surface of the channel letter sign using screws or any other appropriate fasteners.

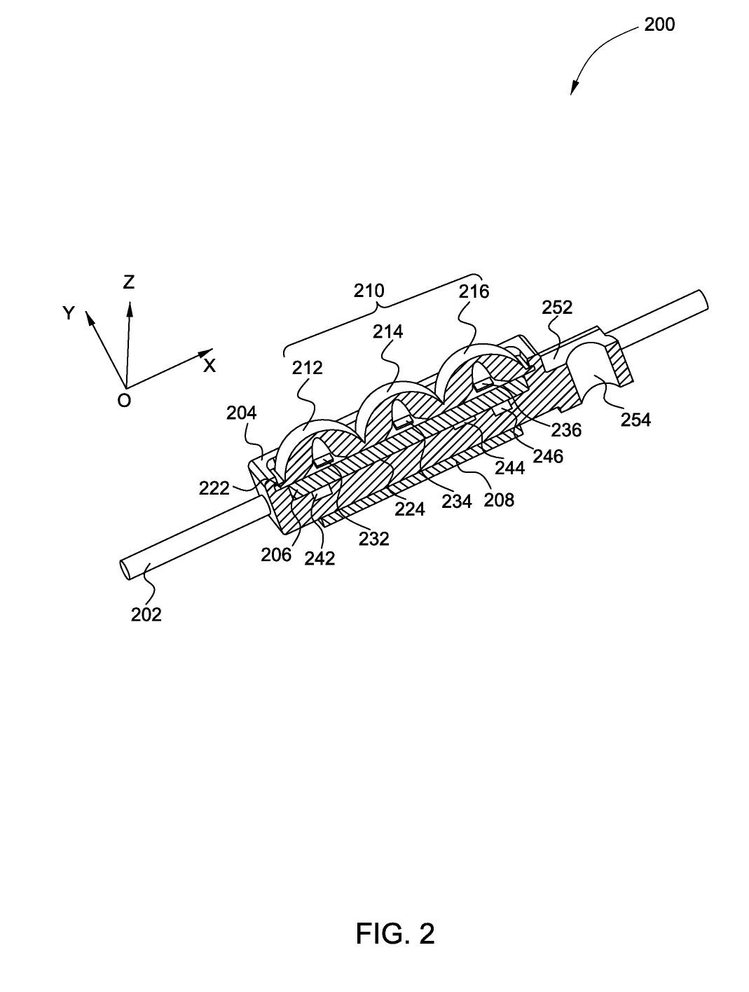

When energized, the first LED light module 110 is operated to direct first light beams (generally designated as 112) emitted from a plurality of first LED light sources (not shown in FIG. 1, will be described in detail with reference to FIG. 2) disposed at the inside of housing 118 of the LED light module 110 at a target plane 140 such as a front face or top surface of a channel letter sign. In the illustrated embodiment, the first LED light module 110 includes an optical element 120 which extends through an opening 122 defined at a top surface of the housing 118 of the first LED light module 110. The optical element 120 is configured to direct light beams emitted from the first LED light sources to the target plane 140 to make the channel letter viewable. In some embodiments, the optical element 120 is configured with refractive surfaces to diverge the light beams emitted from the light sources, such that the target plane can be illuminated with light beams having good optical uniformity. In one embodiment, the optical element 120 is an integrally formed optimal element which includes a first lens 124, a second lens 126, and a third lens 128 that are closely connected with one another. In other embodiments, the optical element 120 may include separately manufactured lenses which may be spaced apart from one another.

In the illustrated embodiment of FIG. 1, each of the first lens 124, the second lens 126, and the third lens 128 is arranged to have substantially the same optical profile. For example, each of the first lens 124, the second lens 126, and the third lens 128 may be arranged to have an asymmetrical optical profile, such that each of the first lens 124, the second lens 126, and the third lens 128 can distribute the light beams emitted from the first LED sources to the target plane 140 asymmetrically. As used herein, “asymmetrical profile” and/or “asymmetrical optical profile” refers to that the optical element or the optical lens is arranged to have at least two different types of optical refractive surfaces for refracting the light beams provided from the LED light sources. For example, the optical element or the optical lens may have one or more curved outer surfaces for diverging the light beams provided from the LED light sources, and one or more flat surfaces for refracting the light beams provided from the LED light sources.

In a specific embodiment, as represented in a O-XYZ Cartesian coordinate system, each of the first lens 124, the second lens 126, the third lens 128 can be configured in manner to allow the light beams 112 distributed in a first light pattern along the O-X direction having a larger light intensity than that of the light beams 112 distributed in a second light pattern along the O-Y direction which is substantially perpendicular to the O-X direction. As such, asymmetrical light patterns of the light beams emitted from the LED light sources can be achieved. In other embodiments, it is contemplated that not all the three lens 124, 126, 128 are configured to have asymmetrical profiles. Instead, at least some of the lens 124, 126, 128 can be arranged to have symmetrical profiles. For example, in some embodiments, the first lens 124 and the third lens 128 may be arranged to have an asymmetrical profile, and the second lens 126 is arranged to have a symmetrical profile. One example of the symmetrical profile of the optical lens 126 is a rotated symmetrical profile such as a spherical surface.

In a similar manner, the second LED light module 130 is operated to direct second light beams (generally designated as 132) emitted from a plurality of second LED light sources (not shown in FIG. 1) at the target plane 140 of the channel letter sign. In some embodiments, a pitch between the first LED light module 110 and the second LED light module 130 can be adjusted to allow the second light beams 132 emitted from the second LED light module 130 to be overlapped with the first light beams 112 emitted from the first LED light module 110 to ensure uniform light distribution on the target plane 140.

In the illustrated embodiment, the second LED light module 130 includes an optical element 150 which extends through an opening 142 defined at a top surface of the housing 138 of the second LED light module 130. The optical element 150 is configured for directing light beams emitted from the second LED light sources to the target plane 140. In one embodiment, the optical element 150 is an integrally formed optimal element which includes a first lens 144, a second lens 146, and a third lens 148 that are connected closely with one another. In other embodiments, the optical element 150 may include separately manufactured lenses which may be spaced apart from one another.

In the illustrated embodiment of FIG. 1, each of the first lens 144, the second lens 146, and the third lens 148 of the second LED light module 130 is arranged to have substantially the same optical profile. For example, each of the first lens 144, the second lens 146, and the third lens 148 may be arranged to have an asymmetrical optical profile, such that each of the first lens 144, the second lens 146, and the third lens 148 can distribute the light beams emitted from the second LED sources to the target plane 140 asymmetrically.

In a specific embodiment, as represented in a O-XYZ Cartesian coordinate system, each of the first lens 144, the second lens 146, the third lens 148 can be configured in manner to allow the light beams 132 distributed in a first light pattern along the O-X direction having a larger light intensity than that of the light beams 132 distributed in a second light pattern along the O-Y direction which is substantially perpendicular to the O-X direction. As such, asymmetrical light patterns of the light beams emitted from the second LED light sources can be achieved. In other embodiments, it is contemplated that not all the three lenses 144, 146, 148 are configured to have asymmetrical profiles. Instead, at least some of the lens 144, 146, 148 can be arranged to have symmetrical profiles. For example, in some embodiments, the first lens 144 and the third lens 148 may be arranged to have an asymmetrical profile, and the second lens 146 is arranged to have a symmetrical profile. One example of the symmetrical profile of the optical lens 146 is a rotated symmetrical profile such as a spherical surface.

Referring to FIG. 2, a cross-sectional view of an LED light module 200 is shown in accordance with an exemplary embodiment of the present disclosure. The LED light module 200 can be used as the first LED light module 110 and/or the second LED light module 130 shown in FIG. 1 for directing light beams to illuminate the target plane 140 (see FIG. 1).

As shown in FIG. 2, the LED light module 200 includes a main body or housing 204 which may be made from over-molded plastic and used to accommodate various elements of the LED light module 200. In one embodiment, the main body 204 may include a channel to allow a conductor 202 such as an electrical wire to enter from one side into the main body 204 and exit from an opposing side of the main body 204. The main body 204 may also include a mounting member 252 integrally or separately connected to the main body 204. In one embodiment, the mounting member 252 is formed with an opening or through hole 254 for mounting or fixing the LED light module 200 to a channel letter can. As described earlier, the LED light module 200 may additionally or alternatively include a double-side tape 208 attached to a bottom surface of the main body 204. In one embodiment, the double-side tape 208 can be attached to a back surface of the channel letter can to fix the LED light module 200 in position with the channel letter can.

In one embodiment, the LED light module 200 includes a circuit board 206 such as a printed circuit board which is disposed inside of the main body 204. The circuit board 206 is electrically coupled to the conductor 202 for receiving electrical current supplied through the conductor 202. In one embodiment, the circuit board 206 includes a first surface 222 and a second surface 224. In one embodiment, the first surface 222 is configured to mount a plurality of LED sources 232, 234, 236. The second surface 222 is configured to mount various other elements, such as a LED controller 242, one or more resistors 244, and one or more diodes 246 which are in electrical connection with at least one of the LED sources 232, 234, 236 to ensure the LED sources 232, 234, 236 to function properly.

In one embodiment, the plurality of LED sources 232, 234, 236 are mechanically and electrically coupled to the circuit board 206 by solder for example. Although three LED sources 232, 234, 236 are depicted in FIG. 2, in other embodiments, the LED light module 200 may include fewer or more LED sources. In some embodiments, the three LED sources 232, 234, 236 are arrayed along a straight line. In other embodiments, the three LED sources 232, 234, 236 may be arrayed along a non-straight line, such as in a circle, semi-circle, an ellipse, and any other appropriate geometry shapes. Also, in the illustrated embodiment, the three LED sources 232, 234, 236 are spaced apart from one another at a predetermined distance. The predetermined distance can be varied according to a number of factors such as the type of the LED sources being used and optical lens used in association with the LED sources.

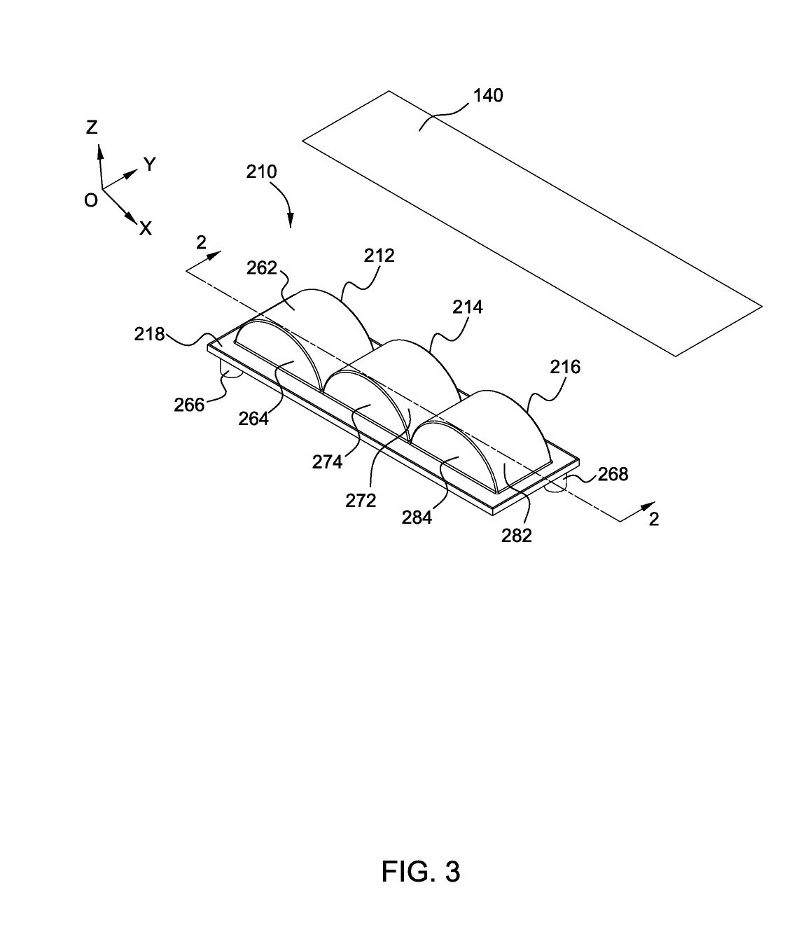

With continued reference to FIG. 2, the first surface 222 of the circuit board 206 is further configured to mount one or more optical elements 210 thereon. Further referring to FIG. 3, the optical element 210 is an integrally formed optical element which includes a first lens 212, a second lens 214, and a third lens 216. In the illustrated embodiment, the first lens 212, the second lens 214, and the third 216 are closely connected with each other without any interconnecting portions. That is, each of the three lenses 212, 214, 216 is physically contacting an adjacent one. In other embodiments, the three lenses 212, 214, 216 may be spaced apart with a distance formed therebetween. Still in some embodiments, the three lenses 212, 214, 216 may be separately manufactured and separately mounted to the circuit board 206.

In the illustrated embodiment, the first lens 212, the second lens 214, and the third lens 216 are also integrally formed with a supporting member 218 which is used for supporting the three lenses 212, 214, 216 thereon. In addition, in one embodiment, the supporting member 218 includes two posts 266, 268 disposed at two corners of the supporting member 218. The two posts 266, 268 extending from one surface of the supporting member 218 are used to be fit into corresponding recesses and/or holes defined in the circuit board 206 to ensure the optical member 210 as well as the three lenses 212, 214, 216 to remain in their proper positions. In other embodiments, the post-hole (or post-recess) mechanical configuration shown in FIG. 3 for mounting together the optical element 210 and the circuit board 206 can be reversed. That is, the supporting member 210 may be formed with recesses and/or holes and the circuit board 206 is formed with corresponding posts for fitting into the recesses and/or holes. It is contemplated that this specific configuration should not be construed as limiting, and the optical element 210 can be mounted to the circuit board 206 using any other appropriate means such as screws and/or adhesives.

Further referring to FIGS. 2 and 3, each of the three lenses 212, 214, 216 defines a hollow chamber for covering and sealing the corresponding LED sources 232, 234, 236. Sealing the LED sources 232, 234, 236 inside the corresponding lenses 212, 214, 216 can prevent dust particles from falling onto these LED sources 232, 234, 236 and also provide moisture resistant and waterproof conditions for these LED sources 232, 234, 236. In some embodiments, the three lenses 212, 214, 216 are made from acrylic and/or polycarbonate material which is also transparent for passing through light beams emitted from the LED sources 232, 234, 236.

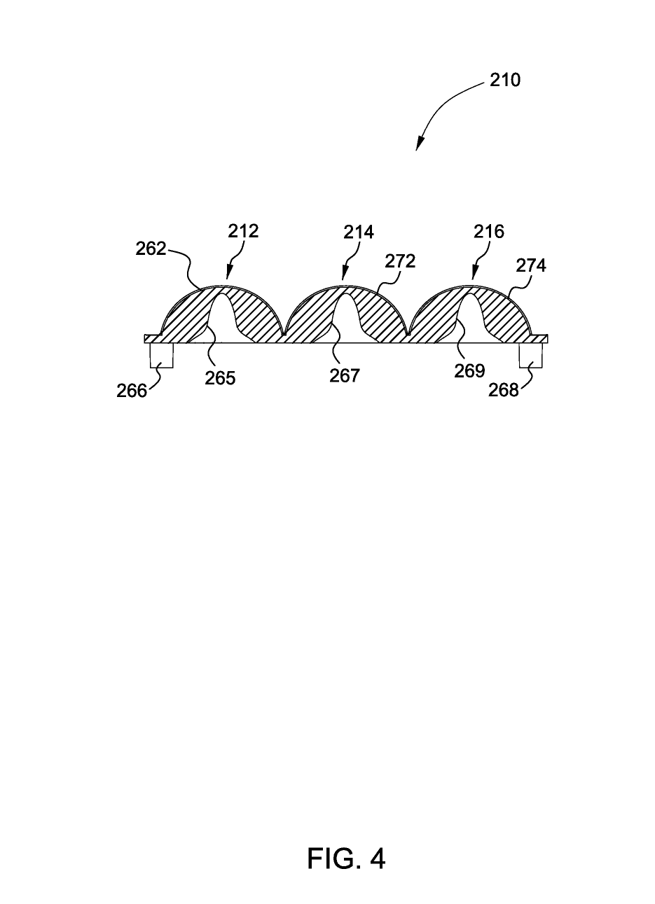

With continued reference to FIGS. 2 and 3 and further referring to FIG. 4, in one embodiment, the three lenses 212, 214, 216 are arranged to have the same profiles. In a specific embodiment, each of the three lenses 212, 214, 216 is arranged to have an asymmetrical profile to distribute light beams emitted from the light sources 232, 234, 236 in an asymmetrical manner. As shown in FIG. 3, the first lens 212 includes a first outer surface 262 which is a curved surface such as a compound curve surface, or more specifically an ellipsoidal surface. In one embodiment, the first outer surface 262 is arranged to have a uniform width measured along the O-Y direction. In other embodiments, the first outer surface 262 may be arranged to have other shapes such as a spherical-shaped surface and a non-spherical-shaped surface.

As further shown in FIG. 4, the first lens 212 further includes an inner surface 265 which is also a curved surface such as a compound curve surface, or more specifically an ellipsoidal surface. The inner surface 265 cooperates with the outer surface 262 to define a wall having a varying thickness from the center of the first lens 212 to the edge of the first lens 212. The varying thickness wall configuration allows the light beams emitted from the first light source 232 to be diverged at a wide angle to a target plane. More specifically, the curved surface 265 configured with a uniform width allows significant portion of the light beams emitted from the first light source 232 to be distributed as a first light pattern along the O-X direction of the target plane 140.

Referring back to FIG. 3, the first lens 212 further includes a second outer surface 264 which is a planar surface in one embodiment. That is, the second outer surface 264 is connected perpendicularly to the first outer surface 262. In addition, the first lens 212 also includes a third outer surface (not viewable in FIG. 3) which is arranged in parallel to the second outer surface 264 and connected perpendicularly to the first outer surface 262. As a result, the first outer surface 262, the second outer surface 264, and third outer surface constitutes the entire outer surface of the first lens 212. The second outer surface 264 is configured to refract the light beams emitted from the first LED source 232 and distribute the light beams in the target plane 140 (see FIG. 1) in a second light pattern. In one embodiment, the planar outer surface 264 is configured to generate the second light pattern having a much smaller intensity than that of the first light pattern generated by the curved outer surface 262. As can be understood, configuring the optical element 210 or the lenses 212, 214, 216 with planar surfaces allows the optical element 210 or lenses 212, 214, 216 to be fit into a channel letter can having a narrower width measured along the O-Y direction. In addition, less or even no light beams are distributed to the side surfaces of the channel letter sign, thus, the efficiency of the LED light module is improved.

As further shown in FIGS. 3 and 4, the second lens 214 and the third lens 216 are configured to have the same optical profile as the first lens 212. For example, the second lens 214 includes a first curved outer surface 272, a second planar outer surface 274, a third planar outer surface (not visible in FIG. 3), and a curved inner surface 267 for distributing light beams emitted from the second LED source 234 asymmetrically in the target plane 140. The third lens 216 includes a first curved outer surface 282, a second planar outer surface 284, a third planar outer surface (not visible in FIG. 3), and a curved inner surface 269 for distributing light beams emitted from the third LED source 236 (see FIG. 2) asymmetrically in the target plane 140. In some embodiments, the light beams emitted from the three LED sources 232, 234, 236 and distributed by the three lenses 212, 214, 216 can be overlapped to make a more uniform light distribution on the target plane 140.

The optical lens 210 shown in FIGS. 2-4 can be modified in a variety of ways. For example, in one embodiment, in the case of covering three LED sources such as the LED sources 232, 234, 236, the optical lens 210 may be an integrally formed optical element configured to have two curved outer surfaces that are connected without any intermediate portions. The optical lens 210 also has planar outer surfaces, such that the light beams emitted from the LED sources 232, 234, 236 can also be distributed asymmetrically in the target plane 140.

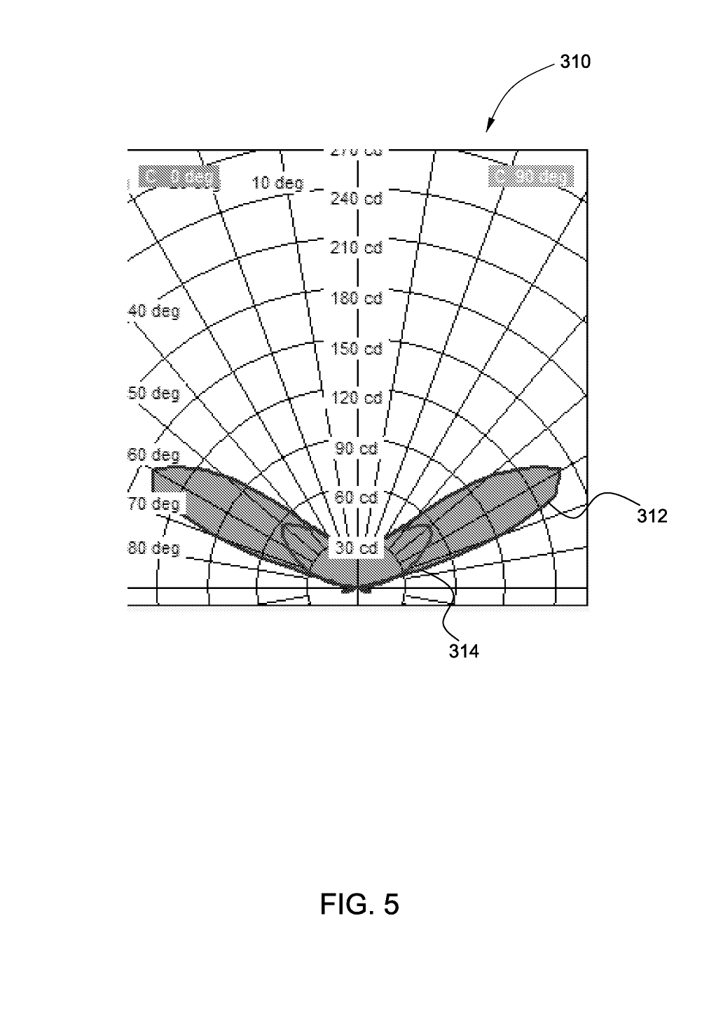

Referring to FIG. 5, which is a polar plot 310 illustrating light distribution of the light beams emitted from one LED light module 200 shown in FIG. 2 in accordance with an exemplary embodiment of the present disclosure. As shown in FIG. 5, asymmetrical light patterns are provided by the LED light module 200. For example, the first light pattern 312 shaped like a “batwing” represents the light beams distributed by the LED light module 200 and measured along the O-X direction. In one embodiment, the first light pattern 312 along the O-X direction can achieve a wide viewing angle of about 140 degrees. The second light pattern 314 represents the light beams distributed by the LED light module 200 and measured along the O-Y direction. The second light pattern 314 has smaller light intensities than the first light pattern 312. Therefore, the efficiency of the LED light module 200 can be increased.

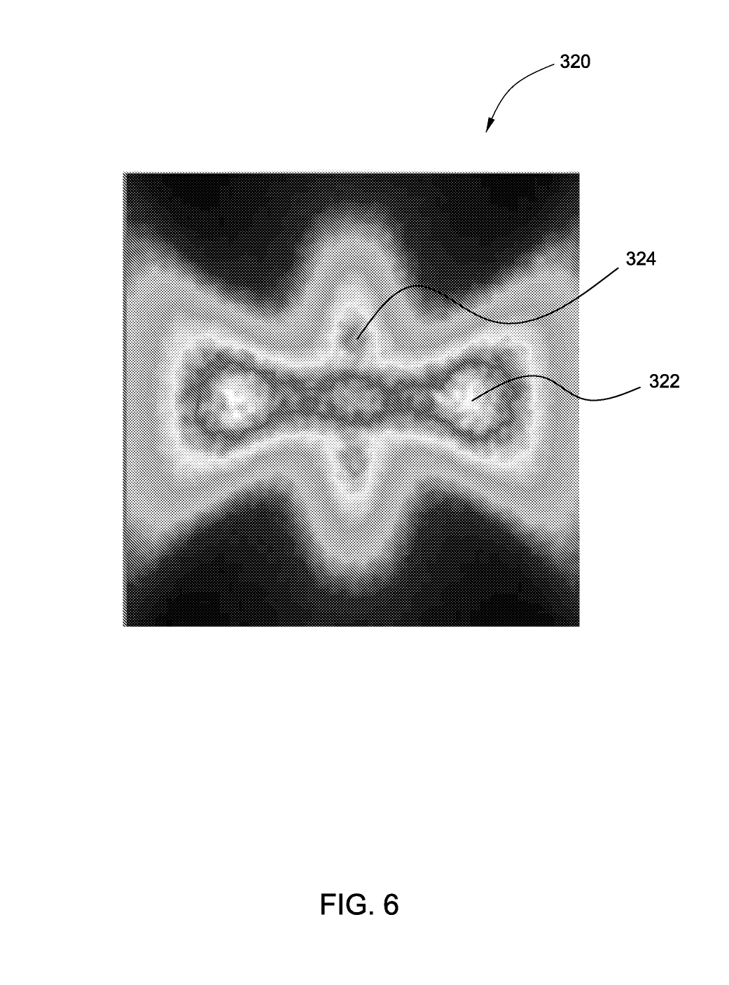

Referring to FIG. 6, which illustrates different illuminance light patterns of the light beams emitted from the LED light module 200 shown in FIG. 2 in accordance with an exemplary embodiment of the present disclosure. As shown in FIG. 6, a first illuminance light pattern 322 which has a substantially strip shape represents the light beams distributed from the LED light module 200 and measured along the O-X direction. A second illuminance light pattern 324 which also has a substantially strip shape perpendicular to the first illuminance light pattern 322 represents the light beams distributed from the LED light module 200 and measured along the O-Y direction. It can be seen that the second illuminance light pattern 324 has a smaller illuminance value than that of the first illuminance light pattern 322. Therefore, the efficiency of the LED light module 200 can be increased.

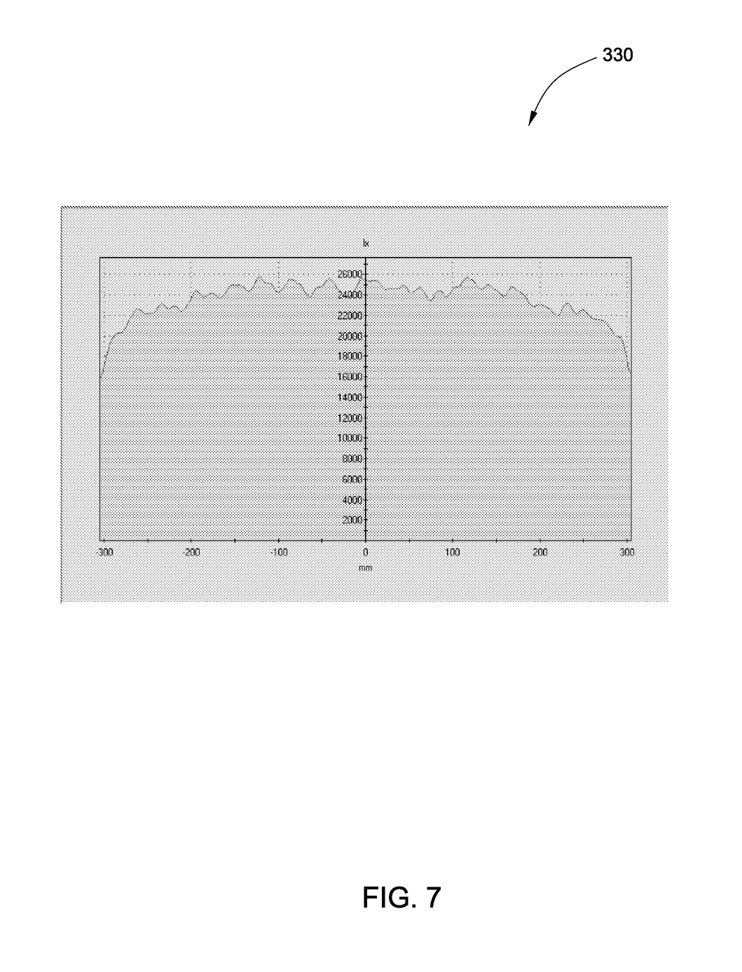

Referring to FIG. 7, which illustrates an illuminance distribution of the light beams generated by five LED light modules in accordance with an exemplary embodiment of the present disclosure. The horizontal axis represents the distance of a position at the target plane relative to the center of the five LED light modules. The vertical axis represents the illuminance value measured at the target plane. As shown in FIG. 7, the light distribution of the improved LED light modules has a light uniformity of about 94% over a range of about 360 millimeters measured along the O-X direction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An LED light module for illuminating a target plane, comprising:
a first LED source;
a second LED source disposed adjacent the first LED source;
a first lens covering the first LED source, the first lens configured to direct first light beams emitted from the first light source to the target plane; and
a second lens covering the second LED source, the second lens configured to direct second light beams emitted from the second light source to the target plane;
wherein at least one of the first and second lenses is shaped to have an asymmetrical profile.

2. The LED light module of claim 1, wherein the first lens and the second lens are integrally formed.

3. The LED light module of claim 1, wherein at least one of the first and second lenses comprises:
a curved outer surface;
a curved inner surface defining a wall having a varying thickness with respect to the curved outer surface, the curved inner surface and the curved outer surface cooperating with each other to direct at least a part of the light beams emitted from the first and second LED sources to the target plane; and
a planar side surface connected to the curved outer surface and the curved inner surface, the planar side surface configured to direct at least a part of the light beams emitted from the first and second LED sources away from the target plane.

4. The LED light module of claim 3, wherein the curved outer surface and the curved inner surface are arranged to have a uniform width measured along one direction in the target plane.

5. (canceled)

6. The LED light module of claim 5, wherein the compound curve surface comprises a spherical surface or an ellipsoidal surface.

7. The LED light module of claim 1, further comprising:
a third LED source disposed adjacent the second LED source; and
a third lens covering the third LED source, the third lens configured to direct third light beams emitted from the third light LED source to the target plane;
wherein at least one of the first, second, and third lenses is shaped to have an asymmetrical profile.

8. A backlighting system, comprising:
a plurality of LED light modules electrically coupled with one another, one of the plurality of LED light modules comprising:
a circuit board;
a first LED source mounted on the circuit board;
a second LED source mounted on the circuit board; and
an optical element mounted on the circuit board and covering both the first LED source and the second LED source, the optical element configured to distribute the light beams emitted from at least one of the first and second LED sources into asymmetrical light patterns.

9. The backlighting system of claim 8, wherein the optical element comprises:
a first lens covering the first LED source and for asymmetrically distributing first light beams emitted from the first LED source; and
a second lens covering the second LED source and for asymmetrically distributing the second light beams emitted from the second LED source.

10. The backlighting system of claim 8, wherein the first lens and the second lens are integrally formed, and at least one of the first lens and the second lens comprises:
a curved outer surface;
a curved inner surface defining a wall having a varying thickness with respect to the curved outer surface, the curved inner surface and the curved outer surface cooperating with each other to direct the light beams emitted from the first and second LED sources to a target plane; and
a planar side surface connected to the curved outer surface and the curved inner surface, the planar side surface configured to direct light beams emitted from the LED sources to the target plane to generate the asymmetrical light patterns on the target plane.

11. The backlighting system of claim 8, wherein the curved outer surface has a compound curve surface.

12. The backlighting system of claim 11, wherein the compound curve surface comprises a spherical surface or an ellipsoidal surface.

13. The backlighting system of claim 8, wherein the optical element further comprises a supporting member integrally formed with the first lens and the second lens, the supporting member comprises at least one post extending from one surface of the supporting member for fitting into a corresponding recess or hole defined in the circuit board.

14. The backlighting system of claim 8, wherein one of the plurality of LED light modules further comprises a third LED source mounted on the circuit board; and the optical element is further configured to cover the third LED source and distribute the light beams emitted from at least one of the first, second, and third LED sources into asymmetrical light patterns.

15. A fixture for presenting a visible sign to a viewer, the fixture comprising:
a target plane; and
a backlighting system for directing light beams to the target plane, the backlighting system comprising a plurality of LED light modules electrically coupled with one another, one of the plurality of LED light modules comprising:
a circuit board;
a first LED source mounted on the circuit board;
a second LED source mounted on the circuit board; and
an optical element mounted on the circuit board and covering both the first LED source and the second LED source, the optical element configured to distribute the light beams emitted from at least one of the first and second LED sources into a first light pattern and a second light pattern different than the first light pattern.

16. The fixture of claim 15, wherein the first light pattern has a substantially strip-shaped pattern, and the second light pattern has a substantially strip-shaped pattern.

17. The fixture of claim 15, wherein the first light pattern is substantially perpendicular to the second light pattern.

18. The fixture of claim 15, wherein the optical element comprises:
a first lens covering the first LED source and for asymmetrically distributing first light beams emitted from the first LED source; and
a second lens covering the second LED source and for asymmetrically distributing the second light beams emitted from the second LED source.

19. The fixture of claim 18, wherein the first lens and the second lens are integrally formed, and at least one of the first lens and the second lens comprises:
a curved outer surface;
a curved inner surface defining a wall having a varying thickness with respect to the curved outer surface, the curved inner surface and the curved outer surface cooperating with each other to direct the light beams emitted from the LED sources to a target plane; and
a planar side surface connected to the curved outer surface and the curved inner surface, the planar side surface configured to direct light beams emitted from the LED sources to the target plane to generate the asymmetrical light patterns on the target plane.

20. (canceled)

21. (canceled)

22. The fixture of claim 15, wherein the fixture comprises a channel letter sign.

23. The fixture of claim 15, wherein the fixture comprises a display lighting device.
